(19) United States
(12) Patent Application Publication
(10) Pub. No.: US 2001/0047397 A1
(43) Pub. Date: Nov. 29, 2001

(54) Method and system for using pervasive device to access webpages

(76) Inventor: David H. Jameson, Chappaqua, NY (US)

Correspondence Address: Arthur Dresner, Esq., Reed Smith LLP, 375 Park Avenue, New York, NY, 10152, US

(21) Appl. No.: 09/777,593

(22) Filed: Feb. 6, 2001

Related U.S. Application Data
(60) Provisional application No. 60/183,670, filed on Feb. 18, 2000.
(60) Provisional application No. 60/188,921, filed on Mar. 13, 2000.

(51) Int. Cl. G06F 15/16

(52) U.S. Cl. 709/217

(57) ABSTRACT

A method and system for retrieving data from a database comprising the steps of: accessing the database via a computer to retrieve data from the database; executing a data transforming program in the computer according to a user specific profile to create transformed view data; storing the transformed view data to a server in the computer with a URL address; and accessing and displaying the transformed data from the server via a pervasive device.

### CROSS REFERENCE TO RELATED APPLICATIONS

This application hereby incorporates by reference the contents of and claims priority to U.S. provisional applications Ser. Nos. 60/183,670 filed Feb. 18, 2000 and 60/188,921 filed Mar. 13, 2000.

### FIELD OF THE INVENTION

The present invention relates generally to the field of systems and methods for retrieving certain portions of web pages existing on an Internet web site and for making those portions accessible from a variety of devices, including a wireless device. The present invention also relates generally to the field of communications over the Internet and more particularly to a method for exchanging data between a client device such as a pervasive device, and a server, and to customize data on that server remotely by the client for use on the client pervasive device. In particular, the invention is directed to a method for allowing remote access to a server in which the client controls the access and data that is presented from the server.

### INVENTION SUMMARY

Many Internet web pages provide information of a particular type, such as news story headlines and brief summaries of the news story. Each such reference typically contains a URL link to the specific news story.

Existing web pages are not laid out in a form that makes them suitable for presentation on a PDA, such as a wireless device sold under the trade name “Palm Pilot”, or other mobile device that has a small screen. The current solution is for owners of web sites to modify their webpages, perhaps making special versions of them, specifically for PDAs or other small screen devices. For example, a Palm Pilot®, model 7, comes with a number of “web clipping” applications. These are essentially local HTML documents stored in the Palm Pilot containing links to web sites that have been specially prepared with content. While wireless services have charged by the number of bytes transmitted/received so that minimizing the “on air” bandwidth to keep costs down has been important, bandwidth today is of significance to users in order to improve the quality of service by minimizing the time involved in obtaining results of requests for information or data. Customers are prepared to pay more for faster service.

The present invention is directed to a method for retrieving information from certain web pages and to a system that includes software that is installed on a computer, enabling a user to create views of data by retrieving data from Internet or Intranet sites, and displaying those views in various formats (static, scrolling, ticker, etc.). Each view can be transformed, using a function key, into a webserver page with a unique URL. The computer providing this function can be a desktop, a departmental or enterprise-wide server, or it could also be installed on the server of an Application Service Provider.

Once the view or views are created by the user, the user can then point a pervasive device, such as a Palm VII or a web-enabled wireless telephone device, to the URL, and that view will be displayed on the screen of the pervasive device. Moreover, if the view includes elements of the internet or intranet site(s) that permits interaction (e.g., entering of stock quotes into the “box” provided by quote.yahoo.com, or entering search criteria into E-Bay), the user of the pervasive device can make that entry into the pervasive device, transmit that entry to the webserver providing the view, and the results will be returned to the client pervasive device, and displayed on the screen of the client pervasive device, thus enabling remote queries. This functionality can be expanded to include the ability to perform business transactions, such as placing stock trades, performing e-commerce tasks, etc., rather than simply retrieving information.

If software, such as the software program known as OmniViewer™ (a commercially available software program for displaying selected information from webstites, offered by DigiPortal Software LLC, OmniViewer is a trademark of DigiPortal Software LLC) is being provided to customers by an access service provider (“ASP”), individual users would have their own (possibly virtual) copy of OmniViewer running on the ASP. The client would be able to configure its remote copy of OmniViewer in a desired manner. By appropriately configuring its remote copy allows a client to send a profile to a manager function maintained at the remote OmniViewer (such as a script manager described in greater detail below). The script manager, as well as other manager functions, such as a download manager (i.e. a manager function for downloading desired information, such as a web page, emails, etc.), could reside on one or more separate servers. The script manager in turn would react to the profile to perform a requested task, such as to retrieve a page of information from a website and extract parts of the website which are of interest, and thus create one or many views, or to retrieve an email from a POP manager, etc. The client could control the transforming of the view into a webserver, and thereby enable a pervasive device to display and interact with the data in that view on and through their pervasive device. Thus the enduser controls what is happening on his virtual copy of OmniViewer which is located on the remote server. Accordingly, the process includes the steps of the user creating a profile using a desktop tool or by remotely controlling their virtual copy of OmniViewer on the server. Alternatively, the user may acquire (purchase, be given, etc) profiles from other sources and the user will then explicitly upload the profile to a script manager, which is part of his OmniViewer server. Once the profile is uploaded to a script manager, it need not be uploaded again, but it can be referred to subsequently by a code. A profile is a set of instructions including such things as (a) the address (i.e. a URL, name of an SQL database, etc.) or whatever other information is necessary to access the source containing the information of interest; (b) instructions (such as source code or compiled or byte code, etc.) that control how the relevant information is extracted from the retrieved page; and (c) configuration information that controls the overall process (e.g., what portion of a page should be retrieved, what http headers to include in transmissions, whether stories associated with headlines should also be retrieved, how often the source should be refreshed, etc.). OmniViewer, through its download manager (such as an HTTP manager for downloading an entire web page, or a POP manager for downloading emails), retrieves the pages or emails according to the loaded profiles. Once the pages are retrieved, the relevant information is extracted using the script manager and becomes available to the user through a variety of mechanisms, such as:

a) Published as traditional HTML pages using standard http protocol;

b) Converted to formats such as WML for access via WAP phones;

c) Emailed to the user;

d) Faxed to the user;

e) Remote printed to the user;

f) Telephone call to the user using voice synthesis to read the headlines—user will be able to send commands back by touch-tone or voice;

g) Converted to XML so that it can be sent to or retrieved by a variety of special purpose viewers (and a viewer in this case could be the fax machine or the mobile telephone receiving a call). In this situation, OmniViewer would wrap the cleaned up results in XML along with other XML commands that could be used to control a remote “viewer”. Remote viewers could request OmniViewer to send them an XML-wrapped command (pull mode) or OmniViewer could push XML commands, or email messages, faxes, etc. to known remote viewers.

### OBJECTS OF THE INVENTION

The object of the invention is to provide a method and system by which certain portions of web pages can be presented in a format suitable for wireless appliances or other low bandwidth output devices.

The solution presented works well with web sites that contain headlines either with or without summary text for that headline. If summaries are provided, they may be available on a separate URL. The summary text is typically a couple of paragraphs describing the story. You are still able to click on the headline to jump to the full story. For example, by using a web browser, a user can access particular webpages where news headlines, together with short descriptions of the news story are displayed. One such webpage is offered by the Yahoo web site.

The URL for this particular webpage is known as Yahoo Top Stories and is located at http://dailynews.yahoo.com/headlines/ts/. This webpage displays feature headlines for news stories of the day. Links are provided to other URL's for viewing the full story.

Methods and systems now exist for identifying and extracting particular types of information from a webpage for display. One such commercially available product is the OmniViewer software package referred to above, which is used for retrieving headlines from news services that are provided over the Internet. OmniViewer takes advantage of the type of layout presented on the Yahoo Top Stories webpage and many other webpages that contain headlines and also include summary text for that headline.

When OmniViewer retrieves a webpage (such as the Yahoo Top Stories webpage), it typically extracts numerous aspects of a headline, and generates other information associated with that headline, such as a time stamp for example. Some of the aspects extracted include:

1) The text of the headline—this is what you see in a ticker;

2) The URL associated with the headline that leads to the full story—the content of the page associated with that URL is retrieved when you click on the headline in the ticker; and

3) The summary associated with the story—this information pops up automatically in OmniViewer as you move your mouse over different headlines in a story. Other information (such as a time stamp) may also be included.

A feature of the present invention is to be able to make this information available to a PDA user without simply dumping the headlines and all the summaries directly to the PDA because this involve lots of transmitted bytes and the user, who is probably not interested in all of the items, should not have to pay for the unwanted information and data.

The solution involves the following steps:

1) OmniViewer retrieves the headlines and the summaries;

2) It associates each summary with a newly created URL;

3) The headlines are accessible to the individual user using a specific server (which is implemented in the OmniViewer product as just another viewer);

4) The headlines now contain links to the summaries;

5) The user accesses his copy of OmniViewer remotely using his PDA or other browser;

6) The user can optionally click on a link to read the summary.

Further objects of the invention include a method for retrieving data from a database comprising the steps of accessing the database via a computer to retrieve data from the database; executing a data transforming program in the computer according to a user specific profile to create transformed view data; storing the transformed view data to a webserver in the computer with a URL address; and accessing and displaying the transformed data from the webserver via a wireless device. The database is typically the worldwide web. The database may also be an intranet. The data may be news story data. The data may be stock quote data. The data transforming program may be virtually provided by an ASP. The step of transmitting queries from a wireless device to a webserver may be included. Presenting the transformed view data is in static format may be included. The transformed view data may be in scrolling format. The transformed data may be in ticker format. The transformed data may also be a graphic view, for example to see a stock chart. The transformed view data is transformed according to a command from a function key application. The text of news stories may also be extracted from web pages using headline summaries wherein the URL associated with the headline of the news story is retrieved. The text of a summary associated with the news story may be displayed automatically when a pointer from a mouse is moved over the headline.

It is a further object of the invention to retrieve headlines and summaries from a web page using the steps of: accessing a first web page using a computer; accessing the computer via a wireless device; requesting by the wireless device headlines from the first web page from the computer; republishing the headlines to a second web page in the computer wherein the second web page presents the headlines with links to the summaries; accessing links from the wireless device to display the summary. The data transforming program (such as the script manager part of the OmniViewer software) may be run at a central server. The user specific profiles may be uploaded to the central server before the step of executing the data transferring program is performed. The data transforming program transforms the data into HTML (Hyper Text Mark-up Language) format. The data transforming program transforms the data into WML (Wireless Mark-up Language) format. The data transferring program transforms the data into XML format. A wireless device for accessing web pages including a transceiver for sending wireless messages, a wireless operating system application, and a processor for executing the wireless operating system comprising: a data transforming program executing on the wireless operating system; a webserver for including the transformed view data from the transforming program; and a display for displaying transformed view data from the transforming program.

### BRIEF DESCRIPTION OF THE DRAWINGS

FIG. 1 is a diagram of an index of news story categories;

FIG. 2 is a diagram of Yahoo® top stories;

FIG. 3 is a diagram of an example of the linked text of a news story from FIG. 2;

FIG. 4 is a diagram of an index of news story categories;

FIG. 5 is a diagram of extracted stock prices;

FIG. 6 is a diagram of news headlines;

FIG. 7 is a block diagram illustrating one embodiment of the method and system of the invention;

FIG. 8 is a block diagram illustrating another embodiment of the invention; and

FIG. 9 is a flow chart illustrating the steps of the invention.

### DESCRIPTION OF THE INVENTION

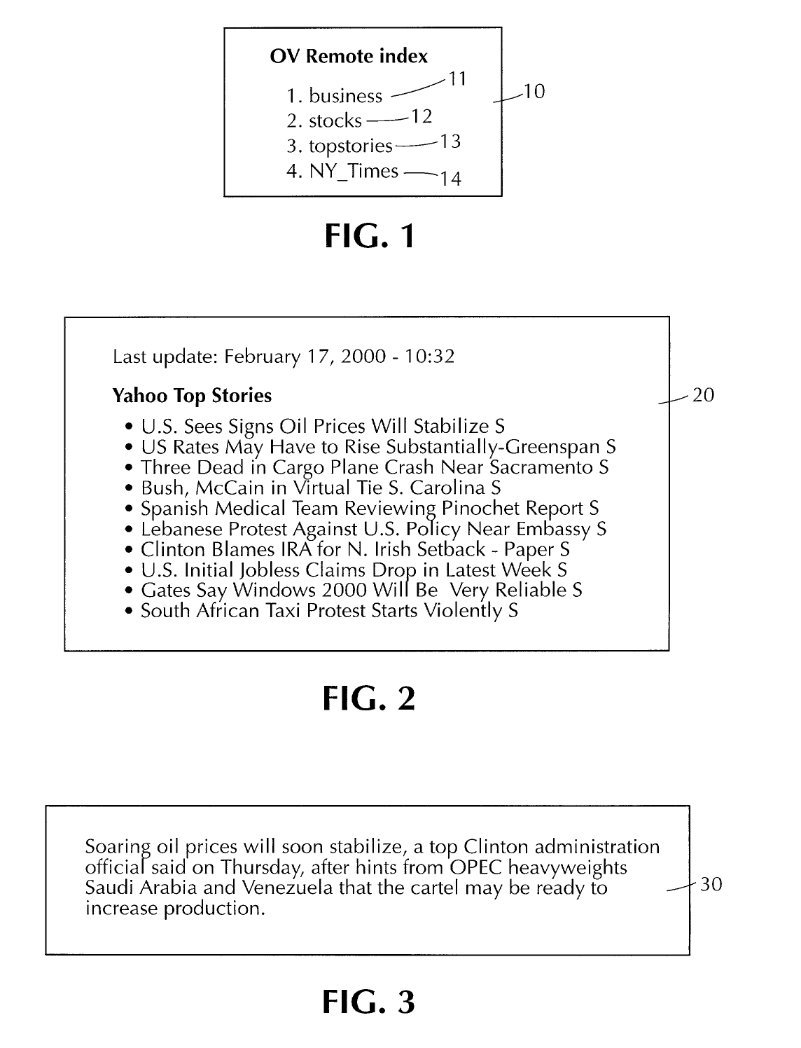

A user employing the OmniViewer product will be able to view a menu 10 of four possible selections of news story categories, such as shown on FIG. 1. The four categories include “business” 11, “stocks” 12, “top stories” 13 or “NY Times” 14. Omniviewer will extract certain information from the news services providing this information for display on separate pages. So, for example, if the user wishes to view the top stories for the day of use that are typically displayed on the Yahoo Top Stories web page, he will click on the “top stories” 13 on menu 10. This will link to a page 20 shown on FIG. 2, which displays the same headlines that are displayed on the Yahoo® Top Stories web page for a particular day, which in the illustration of the figures is Feb. 17, 2000, and which have been extracted by the OmniViewer product. Each headline has a highlighted “S” beside it. This is the hyperlink to the summary. If you click on it, you will be linked to another page to display the summary for that headline.

For example, if you were to click on the “S” next to the first headline on page 20, you would be linked to page 30, see FIG. 3, which displays the same summary for this headline that is displayed on the Yahoo® Top Stories web page.

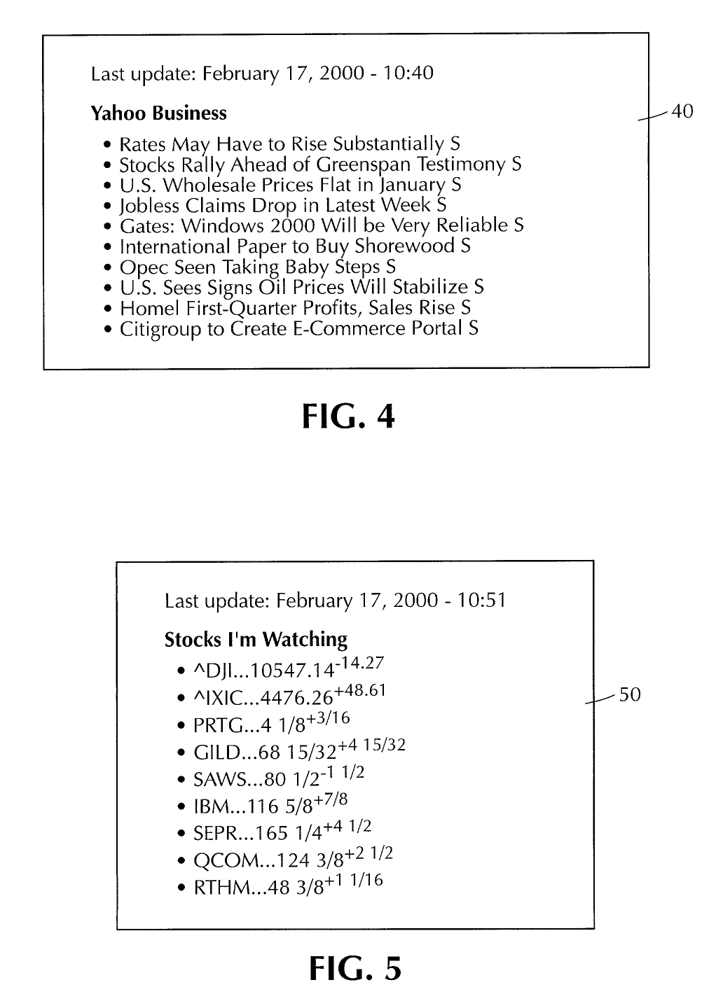

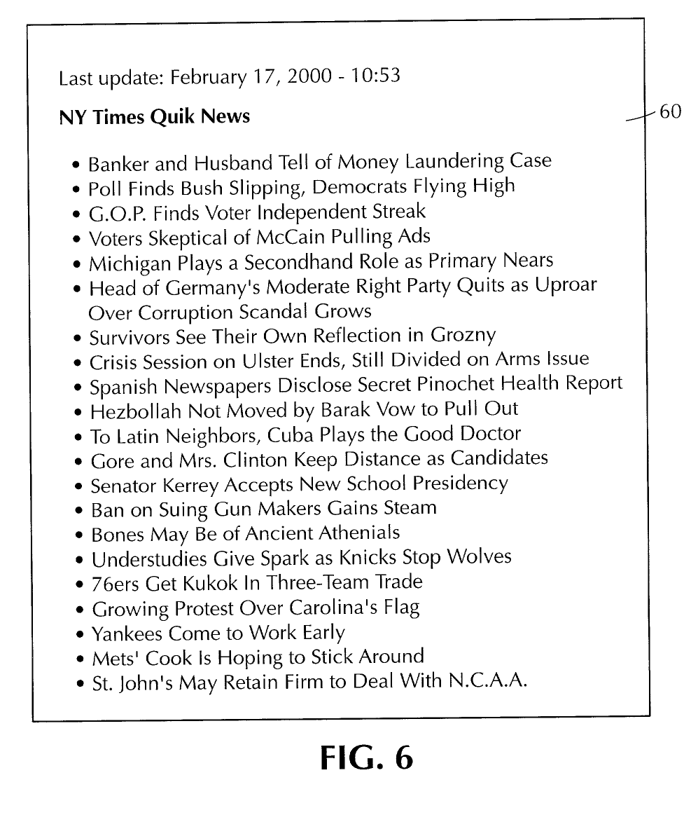

Referring once again to FIG. 1, if the user clicks on the field 11—“business”, the user will be linked to a page 40 shown on FIG. 4, which displays business headlines that OmniViewer extracted from the Yahoo business webpage. Similarly by clicking on fields 12 or 14, the user will be linked to pages 50 and 60 respectively, shown on FIGS. 5 and 6 respectively, in order to view headlines extracted from certain stock listings or from the NY Times Quick News service respectively.

Thus a user of a wireless appliance that is capable of accessing the Internet can now view the headline information and the brief summary information without being burdened by all the information provided by the headline or news service.

The following is a more specific example of how the process operates. Profiles are created by endusers using a desktop program (such as the desktop version of OmniViewer) or profiles can be acquired from another source. A profile is a set of instructions including such things as (a) the address (i.e. a URL, name of an SQL database, etc.) or whatever other information is necessary to access the source containing the information of interest; (b) instructions (such as source code or compiled or byte code, etc.) that control how the relevant information is extracted from the retrieved page; and (c) configuration information that controls the overall process (e.g., what portion of a page should be retrieved, what http headers to include in transmissions, whether stories associated with headlines should also be retrieved, how often the source should be refreshed, etc.). Those profiles can be used on the desktop version of OmniViewer to cause OmniViewer to retrieve information from some source (web, email, sql, whatever) and process the retrieved information to make it available in a variety of viewers on the desktop or remotely using the desktop version of OmniViewer as a webserver.

The server program will now execute compiled profiles on behalf of individual users. Users with profiles (which they have created themselves using a tool such as the desktop version of OmniViewer or which they have acquired in some other way, such as through a profile creation service, or freely available profiles from others) will be able to upload those profiles (or a compiled version of those profiles) to a central server. Upon the request of the user (which the user can also setup to be automatic and periodic), the profile will be “executed” by the server. This will cause the server to request a webpage (or other source, etc.) on behalf of that individual user. When the server receives the information, it will be processed or cleaned up according to the instructions in the profile and sent back to the user. The format of the information sent back to the viewer will depend on the way the individual user wants to receive that information according to that profile. For example, the page could be sent back as a plain HTML page if the user is accessing the OmniViewer program remotely through a web browser.

Alternatively, the OmniViewer server might convert the page (or portions of that page) into pieces of WML so that it could be viewed on a mobile phone that supports WAP/WML. In this version, because of the limitations of WML, OmniViewer would break up the story into multiple pieces, each of which is small enough to be received by a WML browser. Extra commands would be injected into the WML to allow the user to request different chunks of the page.

Yet another approach would be for the server to send the information back annotated in an XML format. This would allow “viewers” at the desktop, or on other devices such as internet appliances, to extract just those parts of the content that were displayable on the particular device.

Stated another way, OmniViewer retrieves the pages according to the loaded profiles and once the pages are retrieved, the relevant information is extracted and becomes available to the user through a variety of mechanisms, such as: (a) Published as traditional HTML pages using standard http protocol; (b) Converted to formats such as WML for access via WAP phones; (c) Emailed to the user; (d) Faxed to the user; (e) Remote printed to the user; (f) Telephone call to the user using voice synthesis to read the headlines—user will be able to send commands back by touch-tone or voice; or (g) Converted to XML so that it can be sent to or retrieved by a variety of special purpose viewers (a viewer in this case could be a fax machine or a mobile telephone receiving a call). In this situation, OmniViewer would wrap the cleaned up results in XML along with other XML commands that could be used to control a remote “viewer”. Remote viewers could request OmniViewer to send them an XML-wrapped command (pull mode) or OmniViewer could push XML commands to known remote viewers.

The current approach used by others is a process where the server detects what kind of remote device is requesting information. The server then sends back information in a format suitable for use by that device.

In the approach provided by this invention, the device is responsible to extract the parts of the message that it can use and ignore parts that it cannot use. Thus the enduser controls what is happening on his virtual copy of OmniViewer on the remote server.

To date this approach is used only by the different kinds of viewers that are included with the OmniViewer product, but there is no reason why a hardware device could not implement exactly the same algorithm in hardware.

For example, where a profile that retrieves a page from the web containing stock quotes, the profile would process the page, sending on only the stock quote information. However, along with each stock quote might be information to tell the viewer what color should be used to display the stock. This might happen if the profile does some extra processing where it checks to see if the stock quote is positive, negative or neutral. However, a black/white viewer (such as the screen on an old mobile phone) has no use for the color information and so would just ignore the tags or attributes in the XML file that specify colors to be used.

The algorithm for this is simple. The following is a simple example based on the current usage by OmniViewer: Server sends the following XML tags to a remote viewer.

<headline title=“Here is a headline” color=“red” fullstoryURL=http://someurl . . . ”>

<stockquote symbol=“IBM” price=“99” change=“+1”/>

A viewer that receives these XML tags first decides whether it understands the tag name. For example, a viewer that doesn't understand the tag <stockquote . . . > will simply ignore the entire tag. A viewer that understands the <headline> tag can process it, but can still ignore attributes of the tag that it doesn't understand or that it has been asked (by the user) to ignore.

In terms of the device being responsible for interpreting the tag, this is also quite easy to understand using the “headline” tag as an example. A standard viewer on the desktop would simply display the headline. For example, if the viewer is a ticker, then the headline will be scrolled. However, another viewer could implement speech output. It understands the <headline> tag and knows that it should announce the contents of the TITLE attribute. Note that the server has no idea what kind of a viewer is receiving this information.

There are numerous types of devices that can finction as the client in the system of this invention in order to initiate requests and receive results from particular servers. Examples of such devices include fax machines, internet appliances, PDAs, voice output devices, scrolling ticker devices (or software), newspapers, etc. Such a client can, as described above, upload a profile to a server manager function at the remote OmniViewer and request the return of selected information (or alternatively, request that the information or results of the request be sent to some other location or some other device). The OmniViewer located at a remote server includes a collection of manager functions, which may either be located at the same location or at different locations. For example, a PDA functioning as a client might upload a profile containing a request to a server and cause the results of that request to either come back to the PDA client or be sent to a printer device at some remote location. Similarly, the request can direct that the results be sent to a fax machine device, to a telephone using voice synthesis, or to some other display device.

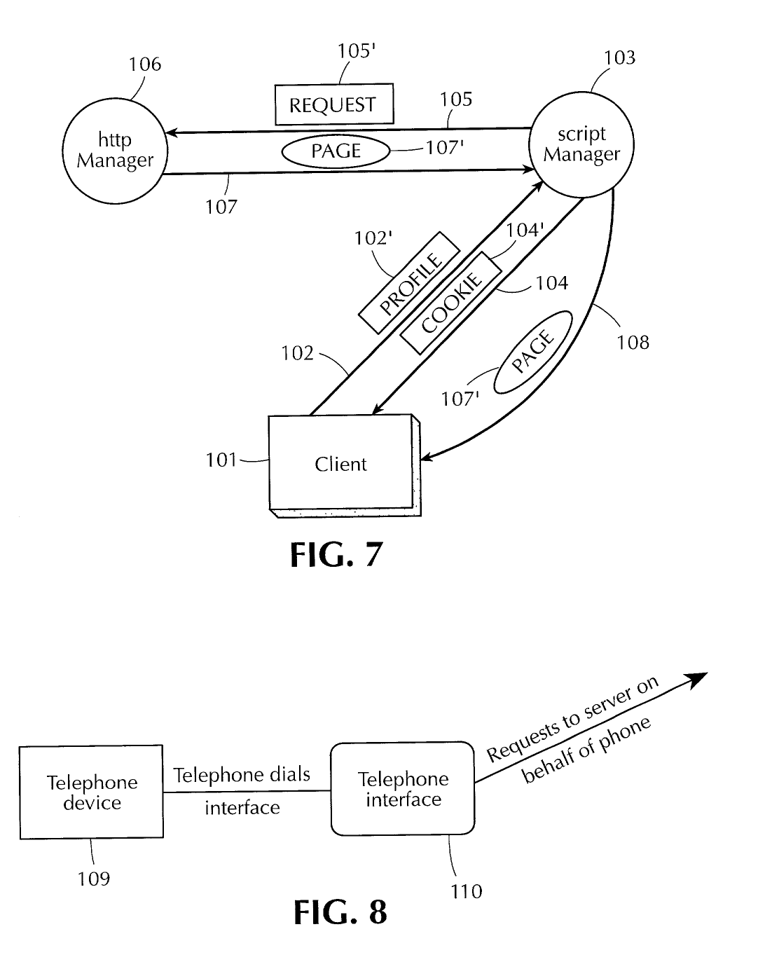

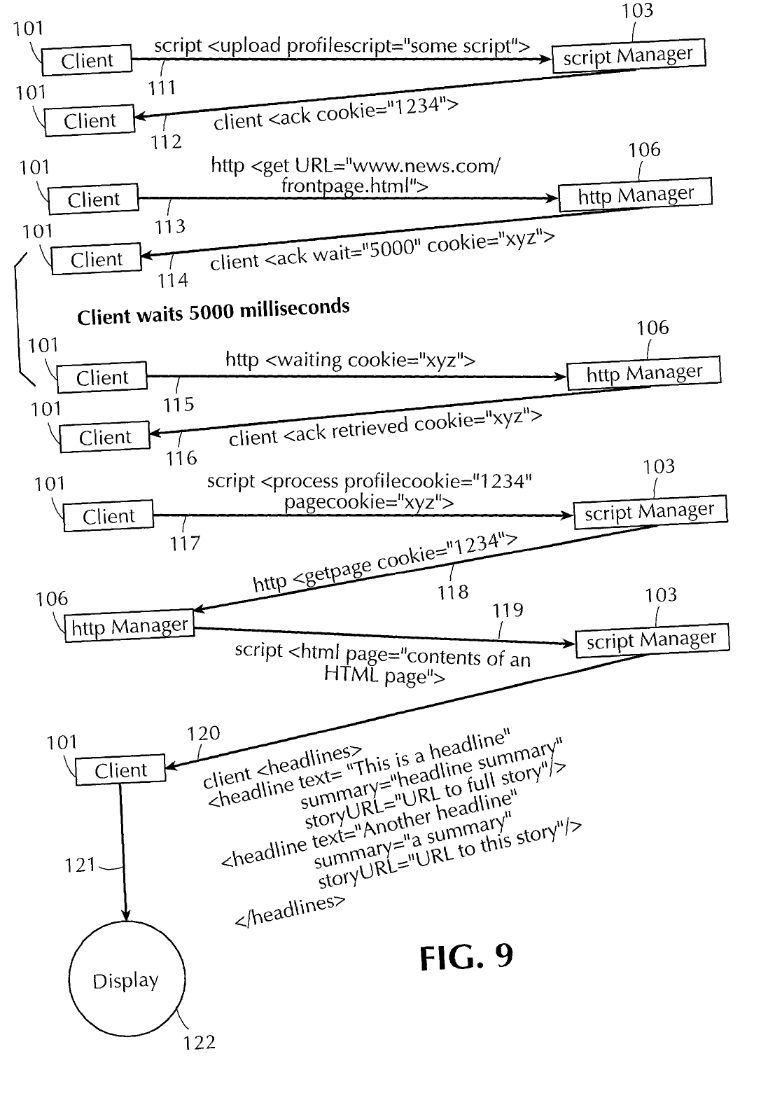

FIG. 7 illustrates in simple diagramatic format the system and method of the invention. In this illustration, a client 101, such as a PDA device, initiates a request by uploading at step 102 a profile 102′ to a manager function, such as script manager 103, located at a remote server. The script manager 103 can also be a stand alone server. The script manager 103, at step 104, may in turn send back to the client 101, a profile cookie 104′ that it can use in subsequent requests made to that script manager, in order to recognize the request from the client. The script manager may also pass that profile cookie 104′ to other servers which may then perform operations on behalf of the original client. At step 105, the script manager 103 will then send a request 105′ to, for example, an HTTP manager 106, to perform a function such as retrieving an HTML page from the worldwide web. That page, 107′, will then be forwarded at step 107 back to the script manager 103 for responding, at step 108, to the client's original request.

Many devices may be used as the client. For example, as illustrated in FIG. 8, a telephone device 109 may be used as an initiating device by sending either touch tones or voice signals to an interface device 110 that is capable of recognizing either the touch tone signals or the voice signals. The telephone interface 110 will then send the initial request on to the server manager functions on behalf of the client telephone device. In addition, there are many stand alone servers that can accept requests from client devices or from other stand alone servers in order to perform particular functions. These stand alone servers may either exist on a single computer or may reside on multiple computers. As noted above, requests are typically sent to the stand alone servers in XML format. In each instance, however, requests/operations occur as the result of an explicit request from a client device as a result of uploading a profile. Examples of stand alone servers that can accept requests either from client devices or from other servers include, for example: a POP manager which will accept requests from client devices to retrieve email messages from a POP server; an SQL manager which accepts requests from client devices to query an SQL database to retrieve specific data; an NNTP manager which will accept requests from client devices to retrieve messages from a newsgroup server; an HTTP manager which accepts requests from client devices to retrieve an HTML page from the worldwide web; a script manager which will accept requests to process a retrieved page of information from some other location and extract the parts of interest requested by the client device; or a periodic manager which is used to set up sequences of repeating requests on behalf of a requester. The nature of the requests to the periodic manager could include a request for the periodic manager to relay or retrieve information at specific time intervals, such as every ten minutes. The periodic manager would then in return ensure that the HTTP manager refreshes the page every ten minutes or at whatever time period is requested. In this manner, the client can receive an updated page at the desired time intervals. The script manager would be accordingly instructed to apply the profile to the updated page so that every ten minutes the client will receive the latest version.

FIG. 10 illustrates in flow chart format a typical series of steps involved in a remote client device requesting information from for example a worldwide web page. At step 111, the client 101 will upload a script profile to the script manager 103. The script manager 103 in turn, at step 112, will send back a profile cookie designated as “1234” denoting the requested page to the client that can be used in subsequent requests made to that server (i.e. the script manager). In addition, the script manager 103 may pass that profile cookie to other servers, such as to an SQL manager or a periodic manager. At step 113, the client will send a request to HTTP manager 106 to obtain from a particular web page located at a URL, such as www.news.com/frontpage.html. The request will be to download that page from a website and store it at the server. The HTTP manager will respond by instructing the client at step 114 to re-initiate the request after waiting 5,000 milliseconds and use a reference such as page cookie “xyz”. At step 115, after waiting the required time, the client 101 will send back page cookie “xyz” to the HTTP manager essentially asking whether or not the requested page has arrived at the HTTP manager server. At step 116, the HTTP manager will acknowledge the request and advise the client that it has indeed retrieved the page. At this point, the HTTP manager 106 does not send the page to the client, but rather merely acknowledges receipt of the page cookie “xyz” and indicates that the page has been retrieved from a website on the worldwide web. At step 117, the client now sends a message to the script manager 103 requesting it to process a web page using the profile cookie “1234”. The reference to the profile cookie “1234” (that was previously uploaded) is sent as the reference to the script manager. It also sends a reference to the page cookie “xyz”. Additional information may also be transmitted to the script manager from the client such as where it may have to go to get that page. The script manager will then contact the HTTP manager sending it, at step 118, a “getpage” request with a cookie referencing the profile “1234”. The HTTP manager at step 119 then sends a message back to the script manager with the actual contents of the page that has been requested. It should be noted here that a client, if it so desires, could also send that “getpage” request with the cookie specifying the page, directly to the HTTP manager who would then be able to respond directly to the client with that requested page. Once the page is at the server, anyone can request it with the proper reference. Typically, however, the client will not do this and rather will go through an intermediate server such as the script manager. This would not be the case if, for example, the client were a browser in which case it might have need for the entire page. Accordingly, the client has its choice and is controlling the HTTP manager by either instructing it to retrieve a particular page and then later, once the page has been retrieved by the HTTP manager, asking for it to be delivered to the client. Alternatively, the client may instruct some other manager, such as the script manager, to perform the function of requesting the HTTP manager to retrieve the page in which case the HTTP manager will send the contents of the page to the script manager (see step 119). The script manager will now use the profile that it had received from the client, apply it to that page, and create, for example, a collection of headlines, summaries, and associated URLs which it now sends at step 120 back to the client. The client can now process that list and at step 121 display them on a display element 122, for example, on a ticker or display it verbally via a voice synthesis or send it to a printer, etc.

It should be appreciated from the foregoing, that the process provides for the client to connect to a remote server, so that the system does not exist solely on a desktop type unit, thus the client device can control the steps of the process by uploading a profile to request information or data.

The invention has been described and illustrated in connection with certain preferred embodiments which illustrate the principals of the invention. However, it should be understood by those skilled in the art that various modifications and changes may readily occur, and it is not intended to limit the invention to the construction and operation of the embodiments shown and described herein.

1. A method for retrieving data from a database comprising the steps of:
accessing the database via a computer to retrieve data from the database;
executing a data transforming program in the computer according to a user specific profile to create transformed view data;
storing the transformed view data to a server accessible by a URL; and
accessing and displaying the transformed data from said server via a client device.

2. The method of claim 1 wherein said client device is a wireless device.

3. The method of claim 1 wherein the database is the worldwide web.

4. The method of claim 1 wherein the database is an intranet.

5. The method of claim 1 wherein the data is news story data.

6. The method of claim 1 wherein the data is stock quote data.

7. The method of claim 1 wherein the data transforming program is virtual provided by an access service provider (ASP).

8. The method of claim 2 further comprising the step of transmitting queries from said wireless device to said webserver.

9. The method of claim 1 wherein said server is a webserver.

10. The method of claim 1 wherein the transformed view data is in static format.

11. The method of claim 1 wherein the transformed view data is in scrolling format.

12. The method of claim 1 wherein the transformed data is in ticker format.

13. The method of claim 1 wherein the transformed data is in voice format.

14. The method of claim I wherein the transformed view data is transformed according to a command from a function key application.

15. The method of claim 4 wherein text of news stories is extracted from web pages using headline summaries.

16. The method of claim 15 wherein the URL associated with the headline of the news story is retrieved.

17. The method of claim 15 wherein a summary associated with the news story is displayed automatically when a pointer from a mouse is moved over the headline.

18. The method of claim 1 wherein the data transforming program is run at a central server.

19. The method of claim 1 wherein the user specific profiles are uploaded to the central server before the step of executing the data transferring program is performed.

20. The method of claim 1 wherein the data transforming program transforms the data into HTML (Hyper Text Mark-up Language) format.

21. The method of claim 2 wherein the data transforming program transforms the data into WML (Wireless Mark-up Language) format.

22. The method of claim 1 wherein the data transferring program transforms the data into XML format.

23. A method for retrieving headlines and summaries from a web page comprising the steps of:
accessing a first web page using a computer;
accessing the computer via a wireless device;
requesting by the wireless device headlines from the first web page from the computer;
republishing the headlines to a second web page in the computer wherein the second web page presents the headlines with links to the summaries;
accessing links from the wireless device to display the summary.

24. A method for a client device to retrieve data from a web page comprising the steps of:
uploading from the client device a script profile to a first server manager;
said first server manager responding to said client device with a profile cookie denoting the request;
sending a request from said client to a second server manager to obtain data from a particular web page located at a designated URL;
said second server manager responding to said request by instructing said client to reinitiate said request after a specified time period and to use a reference to a page cookie sent by said second server manager to said client;
reinitiating said request by said client after said time period with said page cookie to said second server manager;
acknowledging said reinitiated request by said second server manager and advising said client that it has obtained and is in possession of said web page;
sending a message by said client to said first server manager requesting it to process said web page using said profile cookie;
said first server manager contacting said second server manager with a request referencing said profile cookie to retrieve said web page;
said second server manager sending said retrieved page to said first server manager; and
said first server manager sending said web page to said client.

25. The method according to claim 24 wherein said request by said client to said second server manager is to download the page from the designated website and to store it at said second server manager.

26. The method according to claim 24 wherein said time period is 5,000 milliseconds.

27. The method according to claim 24 comprising the additional step of providing said first server manager with information as to where it may retrieve said web page.

28. The method according to claim 24 comprising the additional step of displaying the contents of said page after receipt by said client.

29. The method according to claim 28 wherein displaying said page is a static display.

30. The method according to claim 28 wherein said display is a scrolling display.

31. The method according to claim 28 wherein said display is synthesized speech.

32. The method according to claim 24 wherein said first server manager is a script manager.

33. The method according to claim 24 wherein said second server manager is an HTTP manager.

34. The method according to claim 24 comprising the additional step of requesting a periodic manager to retrieve information from said web page at specified time intervals.

35. The method according to claim 24 comprising the additional step of said client requesting a POP manager to retrieve email messages from a POP server.

36. The method according to claim 24 comprising the additional step of said client requesting an SQL manager to query an SQL database to retrieve specific data.

37. The method according to claim 24 comprising the additional step of said client requesting an NNTP manager to retrieve messages from a newsgroup server.

38. A system for accessing web pages including a transceiver for sending wireless messages, a wireless operating system application, and a processor for executing the wireless operating system comprising:
a data transforming program executing on the wireless operating system;
a webserver for including the transformed view data from the transforming program;
a display for displaying transformed view data from the transforming program.
